(19) United States
(12) Patent Application Publication
(10) Pub. No.: US 2008/0191047 A1
(43) Pub. Date: Aug. 14, 2008

(54) Motor Vehicle Heating System and Method for Pre-Heating Liquid Fuel

(76) Inventors: Vitali Schmidt, Munchen (DE); Burghard Bohme, Neubrandenburg (DE); Harald Miethe, Neubrandenburg (DE)

Correspondence Address: DICKINSON WRIGHT PLLC, 1901 L. STREET NW, SUITE 800, WASHINGTON, DC, 20036, US

(21) Appl. No.: 11/909,821

(22) PCT Filed: Mar. 30, 2006
(86) PCT No.: PCT/DE2006/000581

§ 371 Date: Sep. 27, 2007

(30) Foreign Application Priority Data
Apr. 1, 2005 (DE) 10 2005 015 118.3
Nov. 7, 2005 (DE) 10 2005 052 985.2

(51) Int. Cl. B60H 1/22

(52) U.S. Cl. 237/28

(57) ABSTRACT

The invention relates to a motor vehicle heating system (10) which is embodied in such a way as to be operated by liquid fuel, and comprises a fuel pump (16) and an electromagnetically actuated fuel valve (84; 200) which is arranged downstream from the fuel pump. According to the invention, the electromagnetically actuated fuel valve (84; 200) is embodied in such a way as to pre-heat fuel. The invention also relates to a method for pre-heating liquid fuel for a motor vehicle heating system, whereby the waste heat of an electromagnetically actuated fuel valve (84; 200) is used to pre-heat the fuel.

The invention relates to a motor vehicle heating system which is designed to operate with liquid fuel, which system is comprised of a fuel pump and an electromagnetically actuated fuel valve disposed downstream of the fuel pump.

The invention further relates to a method of preheating liquid fuel for a motor vehicle heating system.

It is known to integrate an electrical heating module in the fuel supply to a motor vehicle heating system, which heating module heats fuel. It is also known to provide an electromagnetically actuated fuel valve, particularly a check valve or shutoff valve, between the fuel pump and the burner and heat exchanger unit.

Heating modules employed according to the state of the art have high power consumption, e.g. 40 Watt, and therefore the practice has been not to employ them during the entire combustion phase of vehicle heating, but only in the starting phase. However, preheating is advantageous for the combustion, because it advantageously increases the enthalpy of the fuel and reduces its viscosity.

Accordingly, the underlying problem of the present invention was to refine the motor vehicle heating system and the method, which system and method have been described generally hereinabove, such that the fuel can be heated during the entire combustion phase of vehicle heating.

This problem is solved by the features of the independent claims.

Advantageous embodiments and refinements of the invention are set forth in the dependent claims.

The inventive motor vehicle heating system represents an advance over the above-described state of the art in that in the inventive system the electromagnetically actuated fuel valve is designed to preheat the fuel. This is achieved by providing a structure of the fuel valve whereby previously unexploited heat generated by the self-heating of the coil of the electromagnetically actuated fuel valve is employed for preheating of fuel.

In this connection, it is deemed to be particularly advantageous if the electromagnetically actuated fuel valve is a coaxial valve (so-called “in-line valve”). Such a valve is characterized by closeness of the fuel flowing through the valve to the region of the winding, such that particularly efficient heat transfer can be attained.

It is preferable for the inventive motor vehicle heating system if the system has a first operating state in which the electromagnetically actuated fuel valve is in the open state and is controlled such that the fuel is preheated, and a second operating state in which said fuel valve is in the closed state and is also controlled such that the fuel is preheated. For the second operating state [(closed state)], the control may be achieved by applying a voltage which is less than the change of state voltage for the electromagnetically actuated fuel valve.

The provision of the two described operating states is advantageous because it enables preheating of fuel during phases when the fuel valve is closed, e.g. when the combustion chamber is being purged with air or is being preliminarily heated [sic]. The thus preheated fuel is then ready for immediate combustion.

In a further possible refinement of the motor vehicle heating system, when the fuel valve is in the second operating state a pulsed voltage is applied to said fuel valve. The fluctuations in the magnetic field enable greater heat production.

In yet another refinement of the motor vehicle heating system, the electromagnetically actuated fuel valve has a magnetic valve piston, which may be provided, e.g., by fabricating the valve piston as a permanent magnet. When a magnetic field is developed in such a fuel valve, which field has magnetic polarity oppositely directed to that in the first operating state, this provides means of reliably avoiding unintentional opening of the fuel valve, and increasing of the sealing force by which the valve is closed; moreover that magnetic field may still be employed for preheating.

According to a further advantageous refinement of the inventive motor vehicle heating system, the electromagnetically actuated fuel valve has at least one electromagnetic coil assembly; and a material having high thermalconductivity is disposed between the coil assembly and a region which comes to be occupied by fuel. The material with high thermalconductivity may comprise, in particular, a metal, e.g. aluminum. The high thermalconductivity material may be embedded or enclosed in another material, e.g. a plastic skin. The essential criterion is that the high thermalconductivity material provide a heat bridge from the coil to at least one region which comes to be contacted by fuel.

According to a preferred embodiment of the inventive motor vehicle heating system, the electromagnetically actuated fuel valve has at least one electromagnetic coil assembly; and a material having low thermalconductivity is disposed between the coil assembly and the environment of the electromagnetically actuated fuel valve. The material with low thermalconductivity may generally comprise any material suitable for thermal insulation, e.g. a foam comprised of plastic and/or metal. Further, the low thermalconductivity material used for thermal insulation may have a layered structure.

The inventive method represents an advance over the state of the art in that, in the inventive method, waste heat from an electromagnetically actuated fuel valve is used to preheat fuel. The associated advantages are similar to or analogous to those mentioned in connection with the inventive motor vehicle heating system, which for purposes of brevity will not be repeated here.

According to a preferred embodiment of the inventive method, the electromagnetically actuated fuel valve is controlled such as to heat fuel when said valve is in its open state or such as to heat fuel when said valve is in its closed state. Here again, the advantages are similar to or analogous to those mentioned in connection with the inventive motor vehicle heating system, and need not be repeated here.

Preferred embodiments of the invention (by way of example) are described in more detail hereinbelow with reference to the drawings.

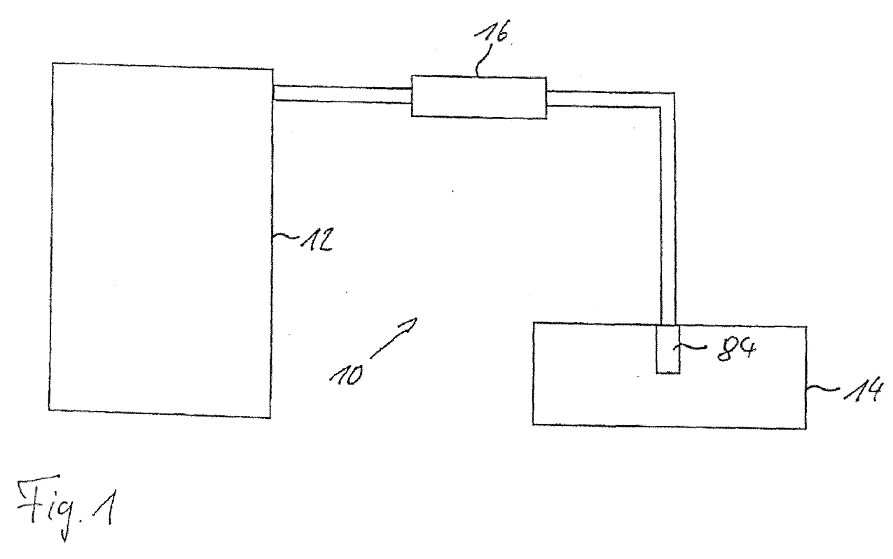

FIG. 1 is a schematic block flow diagram of the inventive motor vehicle heating system;

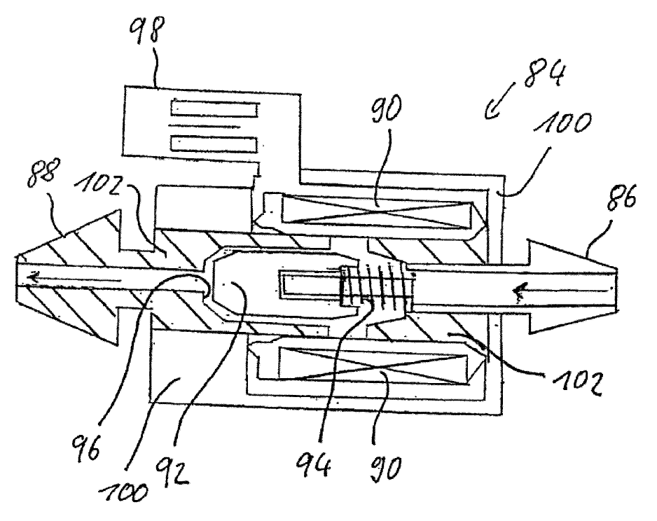

FIG. 2 is a schematic view of a first embodiment of a fuel valve which can be used with the inventive motor vehicle heating system; and

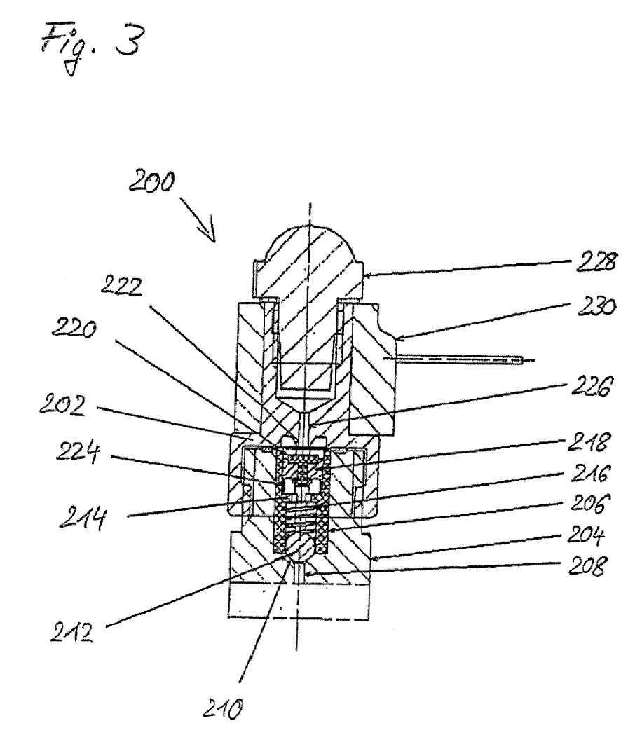

FIG. 3 is a schematic view of a second embodiment of a fuel valve which can be used with the inventive motor vehicle heating system.

FIG. 1 is a schematic block flow diagram of an embodiment of the inventive motor vehicle heating system. This system 10 may operate, e.g., for general supplemental heating or to provide heating under stationary circumstances (when the vehicle is parked). The illustrated heating system 10 comprises a piston fuel pump 16 for pumping liquid fuel from a fuel tank 12 to a burner and heat exchanger unit 14. Depending on whether air or water is being heated, the burner and heat exchanger 14 may communicate with air and water lines (not shown) in a manner which is well known to persons skilled in the art. The burner and heat exchanger 14 also has a fuel valve 84 which can throttle or shut off the fuel supply. It is not mandatory that the fuel valve 84 be integrated into the burner and heat exchanger 14; alternatively it may be disposed between the piston fuel pump 14 and the burner and heat exchanger 14. The heating system illustrated in FIG. 1 does not have a separate heating module for preheating the fuel; instead, according to the invention, the fuel is preheated by waste heat from the fuel valve 84. Alternatively, an additional heating module can be provided, particularly a module of lower power (e.g. 20 watt) than according to the state of the art.

FIG. 2 is a schematic cross sectional view of an embodiment of a fuel valve 84 which may be a component of the heating system 10 according to FIG. 1. Valve 84 is an electromagnetically actuated coaxial valve which has a fuel inlet 86 and a fuel outlet 88. As soon as a suitable voltage (direct current, alternating current, or pulse-modulated) is applied to a terminal 98, an electromagnetic coil 90 is energized, whereby the valve piston 92 is set in motion (rightward in FIG. 2), to open the fuel valve 84, thus allowing fuel to flow from the fuel inlet 86 to the fuel outlet 88. When the coil 90 is in a currentless state, a restoring spring 94 urges the valve piston 92 back (leftward in FIG. 2), wherewith the valve piston 92 interacts with a valve seat 96 to close the fuel valve 84.

The fuel valve 84 illustrated in FIG. 2 is designed for preheating of fuel. Heat generated by the coil 90 is used for heating of the fuel; for this purpose, a material 102 with high thermalconductivity is provided between the coil 90 and the regions with which the fuel comes into contact. Candidates for such material 102 include metals such as aluminum. To optimize the heating of the fuel, a material 100 with low thermalconductivity (a thermal insulator) is provided in the outer region of the fuel valve 84. The low thermalconductivity material 100 may comprise essentially any thermal insulator known to persons skilled in the art, e.g. a foam comprised of metal and/or plastic. The low thermalconductivity material 100 may also have a layered structure (not shown). It is evident [sic] that when the fuel valve 84 is in the open state the energization of the coil 90 will generate sufficient heat to preheat the fuel. The fuel valve 84 may be designed such that a somewhat lower energization of the coil 90, insufficient to open the valve 84, can be employed to achieve preheating of the fuel.

FIG. 3 is a schematic view of a second embodiment of a fuel valve, 200, which is usable with the inventive motor vehicle heating system. The fuel valve 200, in an alternative to the arrangement of FIG. 1, is not integrated into the burner and heat exchanger unit but rather is disposed at the outlet of the fuel pump. The fuel valve 200 has a generally cylindrical valve core 202, one end of which core is generally cup-shaped. The walls of the cup-like shape extend coaxially to the center axis of the fuel valve 200, and parts of said walls have threads. The valve core 202 may be comprised of a high thermalconductivity material. The generally cylindrical connecting nipple element 204, parts of which bear external threads, extends from a fuel pump housing. The fuel valve 200 is mounted on the connecting nipple 204 by screwing-in the internal threads of the valve core 202 over the outer threads of said connecting nipple which are coaxial with the valve core threads. In the inner region of the connecting nipple 204 a generally hollow cylindrical guide bushing 206 is provided which is coaxial to the nipple body; this bushing terminates on its valve-side end at the valve-side end of the connecting nipple 204 and is aligned flush with said end of said nipple. A fuel channel 208 extends from the fuel pump into the interior space of the guide bushing 206. The fuel channel 208 has a larger diameter in the interior of the guide bushing 206 (namely corresponding to the interior diameter of said bushing); between the interior of the guide bushing and the point of junction of the fuel channel with the pump, the diameter of the fuel channel 208 undergoes a narrowing, which may involve e.g. a tapering. The tapered region forms a valve seat 210 which is engageable by a valve ball element 212 which is movably guided in the guide bushing 206 between the valve seat 210 and an inner flange 214 of the guide bushing 206. Said inner flange 214 is formed by reduction of the interior diameter of the guide bushing 206 over a certain longitudinal distance. A compression spring 216 is disposed coaxially between the inner flange 214 and the valve ball 202, which spring 216 pre-stresses the valve 212 in the direction of the valve seat 210. A valve disc or “valve body” 218 is introduced in the end region of the guide bushing 206 opposite to the end region bearing the valve ball 212, which valve body 218 is in the form of a permanent magnet, which is movably guided by the guide bushing 206 between the inner flange 214 and the base of the abovementioned cup shape of the valve core 202. The valve body 218 has coaxially integrated into it a sealing element 220 which covers a central region of the valve-side surface and the pump-side surface of the valve body 218. A nipple-shaped valve seat 222 is formed at the base of the cup configuration of the valve core 202, which valve seat 222 terminates in the plane of the cup base. The sealing element 220 serves to provide a reliable seal when the valve body 218 is pressed against the valve seat 222 (described in more detail infra). A compression spring 224 is installed between the valve body 218 and the inner flange 214, which spring serves to pre-stress the valve 218 in the direction of the valve seat 222. Longitudinally extending flow-around channels (not shown) are provided on the inner side of the guide bushing 206, which allow fuel to flow around the valve ball 212 and valve body. An inflow channel 226 extends from the valve seat 222 along its center axis to a nozzle 228 which is disposed in the end of the valve core 202 which is opposite to that of the cup configuration. In this region there is a generally cylindrical coaxial blind recess which recess has interior threads. Outer threads on the nozzle 228 allow it to be screwed into the inner threads of said recess (and it is so screwed in). The nozzle 228 may be comprised of a high thermalconductivity material. Between the nozzle 228 and the guide bushing 206, the valve core 202 has a magnet coil 230 at its outer periphery coaxial to the center axis of the fuel valve 200.

At the start of operation, fuel is pumped through the fuel channel 208 of the connecting nipple 204, causing retraction of the valve ball 212 (which is pre-stressed by the compression spring 216) from the valve seat 210. This exposes the flow-around channels in the guide bushing 206. When the magnet coil 230 is in a non-energized state, the valve body 218 is pressed against the valve seat 222 by the pre-stressing of the compression spring 224, wherewith the sealing element 220 prevents the fuel from flowing farther to the nozzle 228, and thus the fuel valve 200 is in a closed state.

If it is desired to preheat the fuel in the fuel valve 200 while the valve is in its closed state the magnet coil 230 is subjected to a voltage, preferably a pulsed voltage. The fluctuations in the magnetic field generate thermal energy which heats the channel region of the inlet channel 226 upstream of the nozzle 228, as well as the nozzle itself. The magnet coil 230 is controlled such that the magnetic field can develop only in one direction, namely (in the embodiment illustrated) with the north pole at the nozzle 228. The magnetic field of the valve body 218, which is a permanent magnet, is opposite to the magnetic field generated by the magnet coil 230. Accordingly, the magnetic field of the magnet coil 230 attracts the valve body 218, thus urging the valve body 218 against the valve seat 222 in addition to the similarly directed urging by the compression spring 224. The effect is to enhance the seal between the sealing element 220 and the valve seat 222.

To open the fuel valve 200, the polarity of the magnet coil 230 is reversed (opposite to that for the closed state of the fuel valve with pre-heating), with e.g. continuous energization. The reversal of polarity results in development of a magnetic field by the magnet coil 230 which field has reversed polarity (opposite to that for the closed state of the fuel valve with pre-heating). In the embodiment illustrated, the south pole will now be at the nozzle 228. Consequently, the valve body 218 will be repelled by the magnetic field of the magnet coil 230, such that it moves away from the valve seat 222, releasing the inlet channel 226. The fuel, which has been preheated, flows through the nozzle 228, is ignited, and starts up a heating device (or burner and heat exchanger). Fresh fuel flowing in is also heated by the heat generated by the magnet coil 230 when the valve is in the open state.

When a fuel valve 84 according to FIG. 2 or a fuel valve 220 according to FIG. 3 is employed, one can dispense with the customarily employed heating module. Such modules often have a power consumption of, e.g., 40 Watt, and therefore [sic] are not employed during the entire combustion phase of vehicle heating, but only in the starting phase. The described fuel valves (84; 200) allow preheating of fuel during the entire burner operation, and therefore a higher electric power consumption for them is justified. The preheating increases the enthalpy of the fuel and reduces its viscosity, both with positive effects on the combustion. The multifunctional use of the fuel valve also has the advantages of reducing the cost, physical size, and fabrication time of the vehicle heating system. In many if not all cases, this multifunctional use will allow elimination of a supplemental heating element with its installation means, mounting system, wiring, and control system. Further, the channels for feeding of the fuel are made shorter, thereby reducing the dead volume of fuel.

The features of the invention disclosed in the Specification, drawings, and Claims may be essential individually or in any combination, for realization of the invention.

### List of Reference Numerals

10 motor vehicle heating system.
12 fuel tank.
14 burner and heat exchanger unit.
16 piston fuel pump.
84 fuel valve.
86 fuel inlet.
88 fuel outlet.
90 coil.
92 valve piston.
95 restoring spring.
98 electrical connection.
100 material with low thermalconductivity.
102 material with high thermalconductivity.
200 fuel valve.
202 valve core.
204 connecting nipple.
206 guide bushing.
208 fuel channel.
210 valve seat.
212 valve ball.
214 inner flange.
216 compression spring.
218 “valve body”.
220 sealing element.
222 valve seat.
224 compression spring.
226 inlet channel.
228 nozzle.
230 magnet coil.

1. A motor vehicle heating system (10) which is designed to operate with liquid fuel, which system is comprised of a fuel pump (16) and an electromagnetically actuated fuel valve (84; 200) disposed downstream of the fuel pump; characterized in that the electromagnetically actuated fuel valve (84; 200) is designed to preheat the fuel.

2. A motor vehicle heating system (10) according to claim 1; characterized in that the electromagnetically actuated fuel valve (84; 200) is a coaxial valve.

3. A motor vehicle heating system (10) according to claim 1 or 2;
characterized in that the system has a first operating state in which the electromagnetically actuated fuel valve (84; 200) is in the open state and is controlled such that the fuel is preheated, and a second operating state in which said fuel valve is in the closed state and is controlled such that the fuel is preheated.

4. A motor vehicle heating system (10) according to claim 3; characterized in that when the fuel valve (84; 200) is in its second operating state a pulsed voltage is applied to it.

5. A motor vehicle heating system (10) according to one of the preceding claims; characterized in that the electromagnetically actuated fuel valve (84; 200) has a magnetic valve piston (92; 218).

6. A motor vehicle heating system (10) according to one of the preceding claims; characterized in that the electromagnetically actuated fuel valve (84; 200) has at least one electromagnetic coil assembly (90; 230); and in that a material (102; 202) having high thermalconductivity is disposed between the coil assembly (90; 230) and a region which comes to be occupied by fuel.

7. A motor vehicle heating system (10) according to one of the preceding claims; characterized in that the electromagnetically actuated fuel valve (84) has at least one electromagnetic coil assembly (90); and in that a material (100) having low thermalconductivity is disposed between the coil assembly (90) and the environment of the electromagnetically actuated fuel valve (84).

8. A method of preheating of liquid fuel for a motor vehicle heating system; characterized in that waste heat from an electromagnetically actuated fuel valve (84; 200) is used to preheat fuel.

9. A method according to claim 8; characterized in that the electromagnetically actuated fuel valve (84; 200) is controlled such as to heat fuel when said valve is in its open state or such as to heat fuel when said valve is in its closed state.

10. A method according to claim 9; characterized in that when the fuel valve (84; 200) is in the closed state a pulsed voltage is applied to said fuel valve.

11. A method according to claim 9 or 10; characterized in that when the fuel valve (84; 200) is in the closed state it is energized such that a magnetic field develops, the polarity of which field is opposite to that which develops when said fuel valve is in the open state.
